(19) United States
(12) Patent Application Publication
(10) Pub. No.: US 2013/0163833 A1
(43) Pub. Date: Jun. 27, 2013

(54) SECURITY DEVICE WITH SECURITY IMAGE UPDATE CAPABILITY

(71) Applicants: Hongcheng Wang, Vernon, CT (US); Zhen Jia, Shanghai (CN); Ziyou Xiong, Wethersfield, CT (US); Rodrigo E. Caballero, Crystal Lake, IL (US)

(72) Inventors: Hongcheng Wang, Vernon, CT (US); Zhen Jia, Shanghai (CN); Ziyou Xiong, Wethersfield, CT (US); Rodrigo E. Caballero, Crystal Lake, IL (US)

(73) Assignee: UTC FIRE & SECURITY CORPORATION, Farmington, CT (US)

(21) Appl. No.: 13/821,085

(22) PCT Filed: Sep. 17, 2010
(86) PCT No.: PCT/US10/49200

§ 371 Date: Mar. 6, 2013

(51) Int. Cl. G06K 9/00

(52) U.S. Cl. CPC G06K 9/00288
USPC 382/118; 382/115

(57) ABSTRACT

An exemplary security device includes a controller that determines whether a security credential for an individual corresponds to an authorized credential. The controller also determines whether an acquired image of the individual corresponds to a reference image that is associated with the authorized credential. The controller determines if a correspondence between the acquired image and the reference image satisfies a selected criterion when the security credential corresponds to the authorized credential. The controller updates the reference image responsive to the selected criterion being satisfied. The controller updates the reference image by including the acquired image into the reference image and weighting the acquired image higher than other image information previously incorporated into the reference image.

### BACKGROUND

Security devices are used for a variety of purposes including controlling access to secured areas, items or information. Various devices and techniques are known for deciding when to grant access to authorized individuals. One such technique utilizes face identification and recognition (FIR). Typical FIR systems include a fixed gallery of images of faces of authorized individuals. A probe face image obtained by a face detector or camera is matched to a gallery image to identify the individual. If the individual is not known, the matching process is considered face recognition. If, on the other hand, the individual is known because of some other input to the system such as a personal identification number or security clearance code, the process is called face identification.

There are various challenges associated with using FIR techniques for security purposes. For example, there are variations in an image of an individual's face at different times for different reasons. Lighting conditions and different camera angles influence the ability to determine whether a probe image corresponds to a gallery image. Additionally, different facial expressions can have an impact on the ability to find appropriate correspondence between images. An individual's face also changes over time because of aging or changes in hairstyle, eyeglass styles, facial hair and age. It is difficult to address the many possible variations in the way an individual looks over time for purposes of being able to repeatedly and accurately use an FIR technique.

One suggested approach includes setting up multiple gallery images for each person. Different gallery images are established under different lighting conditions, for example, to attempt to address variations in an image of an individual's face at different times of day, for example. It has also been suggested to use techniques for extracting features from a normalized face image and to process a probe image to identify the same features to make a comparison. Each of these techniques may address some situations, but not all. Additionally, each of these techniques involves additional processing and expense.

Another suggestion is to use infrared or thermal imaging instead of video imaging. The cost associated with such systems is significantly higher and prohibits them from being used in many applications.

### SUMMARY

An exemplary security device includes a controller that determines whether a security credential for an individual corresponds to an authorized credential. The controller also determines whether an acquired image of the individual corresponds to a reference image that is associated with the authorized credential. The controller determines if a correspondence between the acquired image and the reference image satisfies a selected criterion when the security credential corresponds to the authorized credential. The controller updates the reference image responsive to the selected criterion being satisfied. The controller updates the reference image by including the acquired image into the reference image and weighting the acquired image higher than other image information previously incorporated into the reference image.

One aspect of the exemplary security device is that it allows for using image information obtained when an individual is attempting to gain access to a secured area for the dual purpose of determining whether the determined access should be granted and updating reference image information regarding that individual.

An exemplary method of managing security image information includes determining whether a security credential for an individual corresponds to an authorized credential. A determination is made whether a correspondence between an acquired image and a reference image associated with the authorized credential satisfies a selected criterion when the security credential corresponds to the authorized credential. If the selected criterion is satisfied, the reference image is updated by including the acquired image into the reference image. The acquired image is weighted higher than other image information previously incorporated into the reference image.

The various features and advantages of disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates an example security device designed according to an embodiment of this invention.

FIG. 2 schematically illustrates an example image updating technique.

FIG. 3 is a flowchart diagram summarizing an example approach for managing security image information.

### DETAILED DESCRIPTION

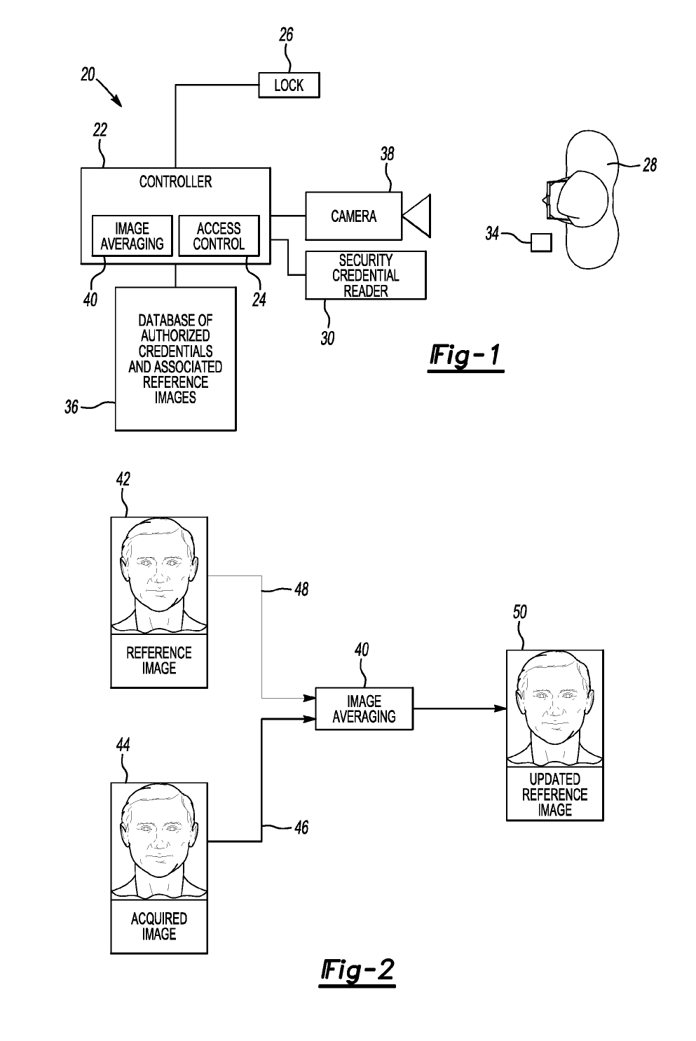

FIG. 1 schematically shows a security device 20 that provides control over whether access to a secured area may be granted and allows for updating security image information. A controller 22 includes an access control portion 24 that provides control over a device such as a lock 26 to maintain security over a secured area, item or information, for example. The controller 22 determines whether an individual 28 will be granted access to a secured area and manages security image information.

The security device 20 includes a security credential reader 30 that obtains security credential information for the individual 28. The illustrated example includes a credential holder 34 such as a smart card, key fob, identification card or another known device. The security credential holder 34 provides credential information to the security credential reader 30. In one example, wireless communication between the security credential reader 30 and the credential holder 34 provides the necessary information to the security credential reader 30 so that an indication of the security credential information may be provided to the controller 22. Another example includes a bar code reader or magnetic strip reader as part of the security credential reader 30. Another example includes a manual input such as a touch screen or key pad that allows the individual 28 to enter security code or identification information so that it is acquired by the security credential reader 30.

The controller 22 determines whether security credential information for the individual 28 corresponds to a known authorized credential within a database 36. If there is a corresponding or matching authorized credential within the database 36, the security credential information obtained by the reader 30 is considered valid.

The controller 22 in this example will not control the lock 26 to allow access to the individual 28 without also obtaining a satisfactory image of the individual 28 from a camera 38. In this example, the camera 38 is arranged to acquire an image of the face of the individual 28. An indication of an acquired image is provided to the controller 22.

The database 36 includes a reference image associated with each authorized credential. The reference image is an image of the individual to whom the authorized credential has been assigned. The controller 22 determines when there is sufficient correspondence between the acquired image and the reference image to grant the desired access to the individual 28. An appropriate correspondence threshold for purposes of granting access to an individual accommodates variations in the acquired image and the reference image of that individual. Given this description, those skilled in the art will be able to select an appropriate correspondence threshold for controlling access to a secured area with a sufficient level of confidence that the individual 28 is the same individual that is the subject of the appropriate reference image.

When there is sufficient correspondence between the authorized credential and the security credential on the one hand and between the reference image and the acquired image on the other hand, the access control portion 24 of the controller 22 determines that the determined access may be granted. The lock 26 may then be unlocked, for example.

The example device 20 allows for using the combination of security credential information and face identification and recognition techniques to control access to a secured area. The example device 20 also manages security image information by facilitating an update of the reference image information regarding an individual. FIG. 2 schematically illustrates an example approach in which an image averaging portion 40 of the controller 22 updates a reference image for an individual. The reference image in this example is shown at 42. The reference image in one example is based upon a captured image of an individual that is used for setting up the database 36 so that the reference image is associated with the correct authorized credential. In some examples, the reference image is based on an average of acquired images during the training or database establishment stage. For example, various images of the individual may be acquired with slightly different lighting conditions and different camera angles, for example. These images are combined and averaged to generate the reference image 42. The initial reference image information may be acquired using the camera 38 or a separate camera dedicated to establishing a reference image.

An acquired image 44 is obtained when the individual presents security credential information at a time that the individual desires access to a secured area. When correspondence between the reference image 42 and the acquired image 44 satisfies a selected criterion, the image averaging portion 40 of the controller 22 updates the reference image 42. There are known image averaging techniques and one example embodiment includes such a known technique.

In one example, the image averaging portion 40 uses an image averaging technique that includes aligning or registering corresponding facial features from the current reference image and the acquired image in a known manner. The aligned facial features are then warped to a canonical space using a known technique. The averaging in this example occurs in the warped space. Given this description, those skilled in the art will be able to select an appropriate averaging technique to meet their particular needs.

As schematically shown in FIG. 2, information regarding the acquired image 44 is weighted differently than information already incorporated into the reference image 42. As shown at 46, the weighting assigned to the acquired image 44 is higher than the weighting assigned to image information previously incorporated into the reference image 42 as shown at 48. The acquired image 44 is the most recent image obtained of a particular individual. That image information is considered the most reliable for how that individual looks especially at the location where access to a secured area is desired. This example includes assigning a higher weight to the most recent image when updating the reference image.

The resulting updated reference image is shown at 50, which comprises a combination of the information used for generating the reference image 42 and the more heavily weighted information regarding the acquired image 44 averaged together to generate the updated reference image 50.

One example includes weighting the previous or older images such that the influence of those images on the updated reference image is in an exponential decay. This approach allows for only the most recently acquired images to have a substantial effect on the updated reference image. An exponential decay rate of influence or effect causes an acquired image to have a substantial effect on the updated reference image for a short time or for a few updates and that allows for more accurately updating the reference image.

The decay rate in one example is based on time. In one such example, the time of an acquired image is one factor that impacts the amount of influence the contents of that image has on the updated reference image. After some time has passed since an image has been acquired, the influence that image has on any subsequent updates of the reference image decreases exponentially.

In another example the decay rate is based on a number of image updates. With each update to the reference image subsequent to an image being acquired, the effect of that image on the updating of the reference image decreases or decays exponentially. In one example, once an acquired image has been used for two reference image updates, the influence of the contents of that image on subsequent updates to the reference image or the weighting assigned to that image decreases significantly at rate corresponding to an exponential decay rate.

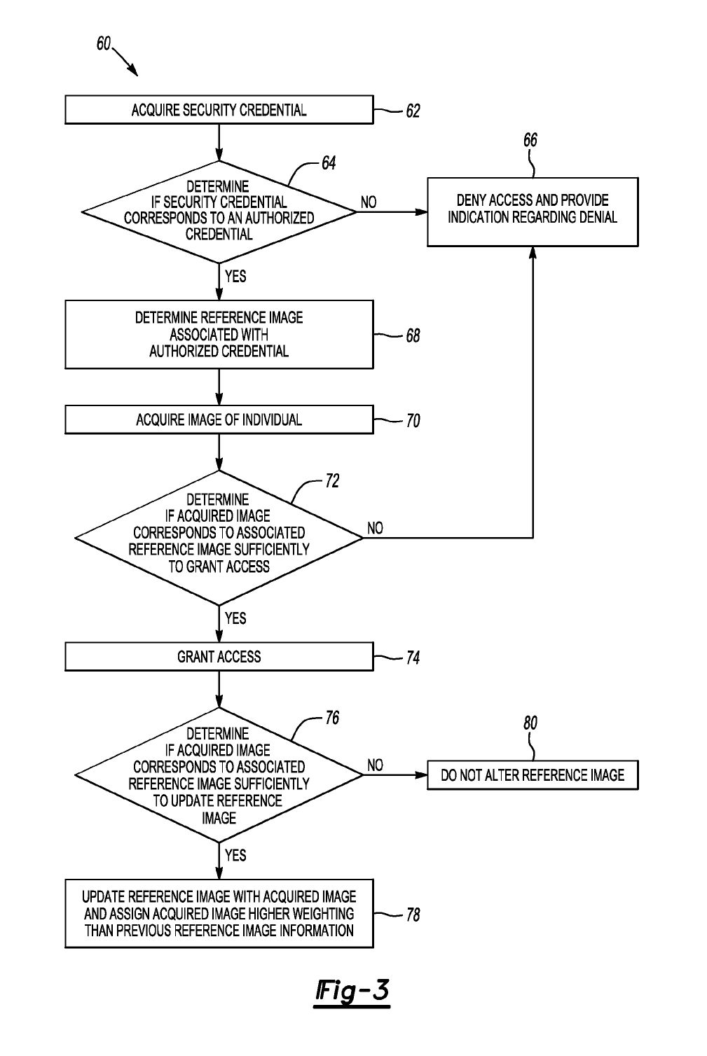

FIG. 3 includes a flowchart diagram 60 that summarizes one example approach. At 62, the security credential information is obtained by the security credential reader 30. At 64, the controller 22 determines if the security credential information corresponds to an authorized credential in the database 36. If not, access is denied at 66. In this example, the controller 22 provides and an indication regarding the denial of attempted access to another device in a security system, security personnel, the individual 28 or a combination of these.

If the security credential information corresponds to an authorized credential, the reference image associated with the authorized credential is identified at 68. An image of the individual is acquired at 70. At 72, a determination is made whether the acquired image corresponds to the associated reference image sufficiently to grant access to that individual. If not, access is denied at 66 and appropriate indications are provided. If there is sufficient correspondence between the acquired image and the reference image associated with the authorized credential that corresponds to the provided security credential, then access is granted at 74.

It is worth noting that the order of steps 64, 68, 70 and 72 need not be sequential as illustrated in FIG. 3. For example, the image of the individual may be acquired before, after or during a time when the determination is made whether the security credential corresponds to an authorized credential. Additionally, it may be possible to acquire the image of the individual before, during or after identifying the reference image associated with the appropriate authorized credential. The particular order of the steps is not as important as performing each of them to confirm that an individual providing security credential information is the correct individual to have that information. When there is sufficient correspondence between the security credential information and the authorized credential information on the one hand and between the acquired image and the reference image on the other hand, it is possible to grant access to an individual desiring such access.

In this example, it is also possible to update the reference image information using the security device 20. A determination at 76 indicates whether the acquired image corresponds to the associated reference image sufficiently to update the reference image. In this example, a first correspondence threshold is used for purposes of determining whether to grant access at 74. A second, stricter correspondence threshold is used for determining whether to update the reference image at 76. It is possible, for example, to accept a lower amount of correspondence between the images for purposes of granting access and to require a closer correspondence between those images for purposes of incorporating the acquired image into the reference image.

As shown at 78, the reference image is updated with the acquired image including assigning the acquired image a higher weighting than image information previously incorporated into the reference image. This allows for updating the reference image with the most current information regarding that individual. As shown at 80, the reference image is not updated if the determination at 76 indicates that there is insufficient correspondence between the reference image and the acquired image.

The disclosed example utilizes access security information to assist in establishing a reference image for a particular individual. Combining a determination regarding security credential information and facial image and recognition techniques allows for more accurately establishing a reference image compared to a purely image-based approach. The ability to update the reference image based on acquired image information obtained at a location where the individual desires access allows for using realistic lighting and other conditions to establish the reference image. This provides for more accurate determinations when subsequent access attempts are made.

Weighting the image information by emphasizing the more recently acquired image allows for robust face recognition that compensates for different illumination conditions when initial reference images are taken during a training phase, for example. It also accommodates for a different viewpoint of the particular camera used at the point where the individual desires access to a secured area.

In one example, the same devices that are used for controlling access are used for establishing initial reference images. This eliminates the need for a dedicated room and special imaging equipment for setting up a database of reference images, for example. Additionally, using the same devices that control access for purposes of updating the image information streamlines the process of updating or expanding an image database used for security control purposes.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A security device, comprising:
a controller that is configured to
determine whether a security credential for an individual corresponds to an authorized credential and an acquired image of the individual corresponds to a reference image that is associated with the authorized credential,
determine if a correspondence between the acquired image and the reference image satisfies a selected criterion when the security credential corresponds to the authorized credential, and
update the reference image responsive to the selected criterion being satisfied, the controller updating the reference image by including the acquired image into the reference image and weighting the acquired image higher than other image information previously incorporated into the reference image.

2. The security device of claim 1, wherein the reference image comprises an image of the individual's face and the acquired image comprises an image of the individual's face.

3. The security device of claim 1, comprising
a credential reader that acquires the security credential from the individual and provides an indication of the acquired security credential to the controller; and
a camera that acquires the image of the individual and provides an indication of the acquired image to the controller.

4. The security device of claim 1, wherein the reference image comprises an average of a plurality of images and the updated reference image comprises an average of the acquired image and the reference image.

5. The security device of claim 1, wherein the controller determines to grant access to the individual when correspondence between the acquired image and the reference image satisfies a first threshold and the controller updates the reference image when the correspondence between the acquired image and the reference image satisfies a second, stricter threshold.

6. The security device of claim 1, wherein
the controller provides an indication of a first condition wherein the security credential corresponds to the authorized credential and the acquired image does not correspond to the reference image and
the controller provides an indication of a second condition wherein the acquired image corresponds to the reference image and the security credential does not correspond to the authorized credential.

7. The security device of claim 1, comprising a database including a plurality of authorized credentials each having an associated reference image and wherein the controller accesses the database.

8. The security device of claim 1, wherein the weighting of the acquired image and the other image information previously incorporated into the reference image results in a decreasing effect of the other image information on an update of the reference image, the decreasing effect decreasing at rate that corresponds to an exponential decay.

9. A method of managing security image information, comprising the steps of:
determining whether a security credential for an individual corresponds to an authorized credential;
determining whether an acquired image of the individual corresponds to a reference image that is associated with the authorized credential,
determining if a correspondence between the acquired image and the reference image satisfies a selected criterion when the security credential corresponds to the authorized credential; and
updating the reference image responsive to the selected criteria being satisfied, the updating comprising including the acquired image into the reference image and weighting the acquired image higher than other image information previously incorporated into the reference image.

10. The method of claim 9, wherein the reference image comprises an image of the individual's face and the acquired image comprises an image of the individual's face.

11. The method of claim 9, comprising
acquiring the security credential from the individual; and
acquiring the image of the individual.

12. The method of claim 9, comprising
establishing the reference image by averaging a plurality of images; and
updating the reference image by averaging the acquired image and the reference image.

13. The method of claim 9, comprising
using an updating correspondence threshold as the selected criteria, the updating correspondence threshold being a correspondence between the acquired image and the reference image that exceeds an access correspondence threshold used for determining whether to grant access to the individual.

14. The method of claim 9, comprising
providing an indication of a first condition wherein the security credential corresponds to the authorized credential and the acquired image does not correspond to the reference image and
providing an indication of a second condition wherein the acquired image corresponds to the reference image and the security credential does not correspond to the authorized credential.

15. The method of claim 9, comprising
storing a plurality of authorized credentials each having an associated reference image in a database.

16. The method of claim 9, comprising
weighting the acquired image and the other image information previously incorporated into the reference image in a manner that results in a decreasing effect of the other image information on an update of the reference image, the decreasing effect decreasing at rate that corresponds to an exponential decay.
